(19) United States
(12) Patent Application Publication
(10) Pub. No.: US 2008/0316743 A1
(43) Pub. Date: Dec. 25, 2008

(54) REMOTE CONTROLLED ATHLETIC FIELD LIGHTING SYSTEM

(75) Inventor: Dwight C. Shaneour, Hillsdale, MI (US)

Correspondence Address: YOUNG & BASILE, P.C., 3001 WEST BIG BEAVER ROAD, SUITE 624, TROY, MI, 48084, US

(73) Assignee: QUALITE LIGHTING, INC., Hillsdale, MI (US)

(21) Appl. No.: 11/764,995

(22) Filed: Jun. 19, 2007

(51) Int. Cl. F21V 21/15

(52) U.S. Cl. 362/233

(57) ABSTRACT

An athletic field lighting system, wherein fixtures are provided in clusters. Each cluster can be turned, on and set to a nominal output level. Thereafter, individual fixture output intensity levels are adjusted by means of feedback loops containing a photosensor mounted in the back of the reflector of each fixture and a pole-mounted logic center which compares commanded and actual output intensities and produces an error signal capable of producing small increments of adjustment by way of dimmer packs associated with individual fixtures. A short, range radio link is provided between an athletic field command center and each of the individual pole-mounted logic systems. A remote link between, a remote control center and the field located control center may be provided as desired.

### FIELD OF THE INVENTION

This invention relates to lighting systems for activity areas such as athletic fields for baseball, football, soccer, and the like and more particularly to a lighting system which provides selectable multiple levels of lighting intensity as well as automatic, adjustment of individual fixture lighting intensity to achieve substantially uniform lighting from all fixtures in an array or grouping of fixtures as well as between all of the fixtures in a multiple, array system.

### BACKGROUND OF THE INVENTION

It is well known to use high intensity lighting fixtures using metal halide lamps and parabolic reflectors to illuminate activity areas such as athletic fields used for baseball, football, soccer, tennis, go-cart racing and other sports activities. The typical installation comprises clusters or groupings of fixtures mounted on cross-arms which are typically mounted on poles surrounding the athletic field to direct high intensity lighting onto the activity area.

The typical system is turned on at a master control location. The system, may be turned off manually or by timers which cut power to the system after a pre-selected amount of operating time or at a particular time of day. Controls can also be provided to permit the energization of fewer than all of the available fixtures where full intensity lighting is not needed.

It is well known that there are small differences between individual fixtures using new lamps and even greater differences between individual fixtures as the lamps age. If lamps are replaced on an individual basis rather than in groups in a large multi-fixture system, the result can be a system with conspicuous differences in the intensity and color of light from the fixtures.

It is also well known that high-intensity arc-type lighting fixtures require the use of ballasts to control current after the arc is established; i.e., to introduce resistance into the lamp circuit as it transforms quickly from the high-resistance, pre-arcing state to the low-resistance arcing state. Ballasts can take many forms, the most, pertinent of which are the so-called electronic ballasts as described in U.S. Pat. Nos. 7,109,668; 7,139,680; 6,914,395; 6,879,113; 6,541,923; 6,351,081; 6,107,754; 5,550,437; 5,434,478 and 4,441,053 as well as pending application Publication Nos. 2006-0197470 and 2005-0179404.

### SUMMARY OF THE INVENTION

In accordance with the present invention, precise intensity control of individual fixtures as well as a high level of uniformity between all fixtures in an array is achieved. The present invention provides not only an overall intensity command capability which permits the selection of one out of several available overall intensity levels for all of the fixtures in an array, but further provides a feedback style-arrangement, for adjusting the output, levels of individual fixtures in small increments via electronic and other switchable ballasts including capacitive ballasts and resistive ballasts so that ideally all of the fixtures in an array of in multiple arrays produce essentially the same light intensity and color at any given time.

In the preferred embodiment of the invention, a local command center is provided at the activity area where, if desired, an operator can provide inputs through switches or a keyboard or other types of data entry instrumentalities, to select a normal overall lighting intensity level for all the fixtures aimed, at the lighted play area. The selected overall intensity level from the local command center is communicated to logic systems mounted close to the fixtures; e.g. on the supports (poles) for the individual clusters, and from this point, intensity commands are delivered to multi-level intensity control units, hereinafter termed “dimmer packs”, which preferably contain electronic ballasts capable of adjusting the intensity level of one or more individual fixtures in small increments between larger nominally selected increments in accordance with signals received from photosensors associated with each individual fixture. For example, if the light, outputs from two out of eight individual fixtures in a cluster are below the level selected for all eight fixtures, the sensors associated with those fixtures develop signals indicating the low output intensities, and these signals are used to adjust the intensity level upwardly in increments via the dimmer packs until all of the fixtures in the cluster are producing light at substantially the same intensity level.

The data transfer between the command center and the logic circuits associated with the dimmer packs can be hard wired but, in the preferred embodiment described herein, is accomplished by a short range RF link providing two-way data transfer. Within the logic itself is a feedback loop including the commanded or requested intensity signal and an actual intensity signal from the sensor. If the two match, there is zero error and no adjustment is made. If there is an error, an adjustment of the correct size and sense is made.

If, for example, the sensor signal indicates that a given lamp is effectively producing no light at all, that information, along with the fixture location identity, is sent back to the control center via the RF link.

Intensity commands can also come from a remote control, location by telephone line, RF, VHF, or cell phone to the field center. A system for the remote control of lighting is described in U.S. Pat. No. 6,922,679 for “Software Integration Method to Automate Lighting Control at Parks and Recreation Facilities,” the entire disclosure of which is incorporated herein by reference.

In a specific system, selectable intensity levels may be associated with “practice”, “league play”, and “tournament play”, each nominal level calling for a higher level of light intensity within the maximum capabilities of the overall system. Between each of the “practice”, “league”, and “tournament” play levels, there are numerous smaller increments of available intensity adjustments producible by the individual fixture dimmer packs so that the output intensity level of each individual fixture can be fine tuned toward overall, system uniformity. The names “practice”, “league” and “tournament” are illustrative rather than exhaustive.

The features and advantages of the invention will be best understood from a reading of the following specification which describes and illustrative embodiment in detail.

### BRIEF DESCRIPTION OF THE DRAWING

FIG. 1 is a perspective view of an athletic field designed for football and illuminated with eight clusters of fixtures mounted on poles for directing light onto the athletic field;

FIG. 2 is a block diagram of a representative portion of the control system for the athletic field lighting system of FIG. 1; and

FIG. 3 illustrates both the nominal and fine timing increments of light intensity levels that are available using the system of FIG. 1.

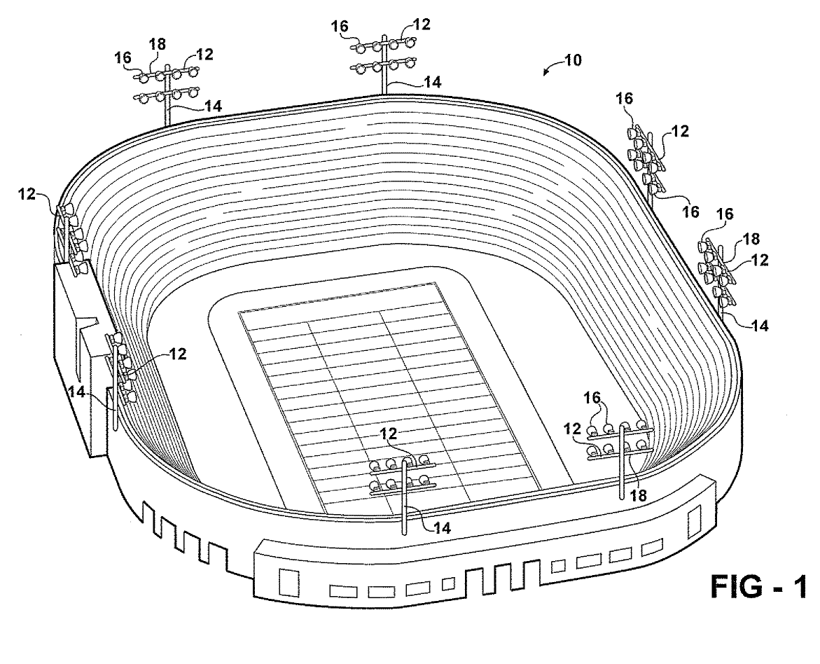

FIG. 1 shows a stadium style athletic field 10 for, as an example, football having a lighting system made up of eight clusters 12 of lighting fixtures 16 mounted on poles 14 at spaced intervals around the outer periphery of the stadium. Each of the poles 14 is provided with cross-arms 18 on which four fixtures 16 are mounted, this number being arbitrarily selected for purposes of illustration only. All of the fixtures 16 are essentially conventional; purely by way of example, they may comprise high intensity metal halide lamps mounted in parabolic polished reflectors to direct light onto the playing field during periods of low ambient light. The lighting system may of course be used for practice as well as for actual play on any of various levels including league play and tournament play.

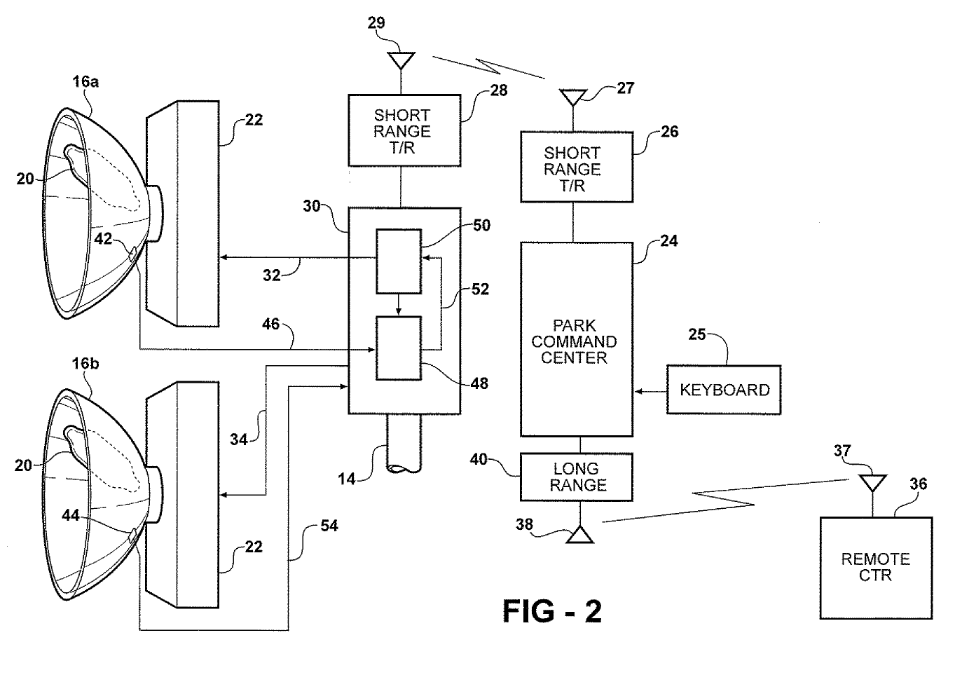

Referring now to FIG. 2, the details of a representative portion of a control system for the athletic field lighting system shown in FIG. 1 will be described in detail, in the illustrated portion of the system shown in FIG. 2, only two lighting fixtures 16 A and 16B are shown with the understanding that they are representative of all of the fixtures 16 in a cluster or array. Each of the fixtures 16A and 16B is equipped with a high intensity 1500 watt, metal halide lamp 20 mounted off axis within the reflector bowl. Again both the wattage and reflector configuration are chosen purely by way of example. The fixtures may be variously accessorized.

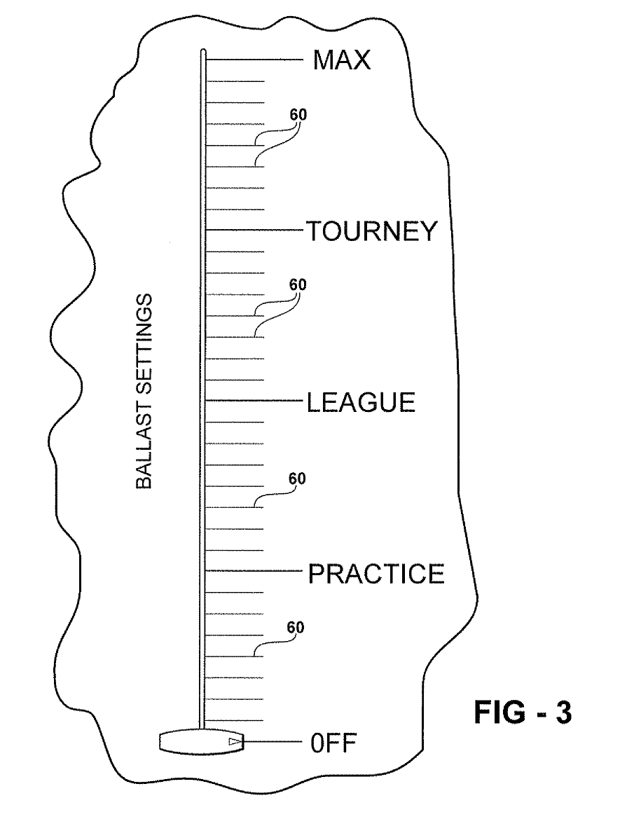

Each of the fixtures 16A and 16B has associated therewith a dimmer pack 22 which is designed to provide ballast and multi-level intensity control; i.e., to provide a large number of selectable increments of light output intensity as indicated by the small increment lines 60 shown in FIG. 3 between the larger nominal intensity levels identified by the legends “PRACTICE”, “LEAGUE”, and “TOURNEY”. Suitable variable ballast dimmer packs 22 are available, from Streetlight Intelligence international Limited of Victoria, British Columbia. These dimmer packs are capacitive systems specifically adapted, for ballasted light fixtures of the type used in municipal street lighting, but are readily adaptable to athletic field lighting of the type described herein. Additional and alternative electronic ballast systems for intensity selection in metal halide lamps are described in the US Patents listed above as well as in U.S. Pat. Nos. 4,612,478; 4,414,493 and 4,453,009, the disclosures of which are incorporated herein by reference. A variable capacitance system for simultaneously varying all of the lamps in a multi-fixture system is described in U.S. Pat. No. 4,994,718 and the principles, of this system can be adapted to the control of individual fixtures as described herein. In addition to variable capacitance systems, variable ballast resistor systems using switching transistors can also be used to implement the dimmer packs 22, it being understood that each dimmer pack 22 provides all of the incremental levels 60 and all of the nominal levels in light output intensity for each associated fixture 16.

As shown in FIG. 2, a field command center 24 is provided at the stadium 10 for providing mass control of all of the fixtures 16 in the lighting system. Operator inputs to the command center 24 may be provided by a keyboard 25 or, alternatively, a system of multiple switches with or without timers or ambient light sensors. The overall control command for the stadium lighting system from center 24 is connected to a short range transmitter receiver 26 having an antenna 27 linked to the antenna 29 of a short-range transmitter receiver 28 associated with each pole 14 and therefore associated with each cluster of fixtures 16A, 16B. The output command from the short-range transmitter receiver 28 is connected to a logic box 30 mounted on the pole 14 and serving both of the fixtures 16A and 16B in the pole-mounted cluster. An output command, for example, for “league” play might be input by the keyboard 25, and coded by the command center 24 and sent by way of the short range transmitter receiver combination 26, 28 to the logic box 30. This command is output by the box 30 over lines 32 and 34 to the dimmer packs 22 associated with the fixtures 16A and 16B to nominally set the output intensity of each of the fixtures as the “league” play level. If the output levels from the fixtures 16A and 16B are identical, the system continues to operate in this manner for as long as lighting is desired. As an alternative to local control, a remote control 36 may also be provided. The remote control center 36 is not at the site of the stadium 10 but some distance away for purposes of administrative convenience. The remote center 36 is equipped with a long range radio control link including an antenna 37 which is linked to an antenna, 38 associated with a long-range transmitter receiver 40 connected to the field located command center 24. In this instance, signals from the remote center 36 are used in place of signals from the remote center 36 are used in place of signals from the keyboard 25 to turn the system on and select the nominal level for lighting intensity. The remote link may be by cellular telephone, short wave VHF radio, UHF radio or hard wired as suits the needs and desires of the specific system designer.

Each of the fixtures 16A and 16B is equipped with a photosensor 42, 44 which produces an output signal, representing the actual, light output intensity from its associated fixtures. Sensor 42 is connected by line 46 to the logic box 30 to provide a feedback signal representing the actual, performance of the fixture 16A. This signal is connected, to a comparator 48 which also receives the nominal output level signal from the set command unit 50 in the logic box 30. If there is a difference between the nominal commanded output level and the actual performance level, the comparator 48 produces an error signal on line 52 which is fed back to the unit 50 to adjust the output in line 52 which is fed back to the unit 50 to adjust the output on line 32 by one or more of the small increments 60 shown between the nominal levels in FIG. 3 so as to create essentially uniform and equal light output intensity in color from all of the fixtures 16A, 16B in an individual cluster. In a system of the type shown in FIG. 1, this also has the effect of creating uniformity between all of the clusters in a multi-cluster system. It will be understood that the logic units 48, 50 shown in the box 30 of FIG. 2 are also used to create a feedback loop for adjustment of the intensity of the output of fixture 16B wherein, the sensor 48 is connected by line 54 to the logic box 30. The logic units 48, 50 may be duplicated, for each fixture or used in a time-shared fashion as will be apparent to those skilled in the art.

In the event one of the lamps 20 burns out, the absence of a signal from the associated sensor 42 during a time when the fixture is expected to be on and producing light is interpreted by the logic box 30 as a burnt out or defective fixture and information regarding: the specific fixture with the burnt, out bulb is sent back to the command center 24 by way of the short range radio link 26, 28. This information can also be used to incrementally increase the light intensity from all of the remaining operational fixtures 16 in the cluster containing the burnt out lamp so that the level of light intensity on the field 10 remains at the desired level. This result is most easily achieved where the logic units 48, 50 are used for all of the fixtures in the cluster and the appearance of a burnt out bulb signal on any of the lines 46, 54 automatically triggers the incremental increase in the intensity level of the remaining operational fixtures.

The field command center 24 may be provided with a maintenance memory and/or a printing capability so as to make of record the fact that an individual fixture contains a burnt out lamp and schedule maintenance by way of the replacement of that lamp at a specific time. To achieve this, each dimmer pack must have its own code and this code must be sent back to the command center 24 along with an indication. A ten digit code similar to that used for garage door operators can be used. The system may also be used to monitor individual, lamp intensities and make a record thereof so as to schedule lamp replacement in an organized and systematic fashion. The field command center 24 is preferably equipped with a microprocessor capability which can readily be programmed to provide these and other accessory type features.

The short range radio link 26, 28 may be provided using UHF, VHF infrared and/or any of a number of alternative short range radio protocols approved by the Federal Communication Commission and capable of carrying the desired data/intelligence level. The “Bluetooth” data protocol has been found acceptable.

While the inventive subject matter disclosed herein has been described in connection with a specific and illustrative system, it is to be understood that not all features of the system need be used together and further that various modifications and additions may be made by designers of individual systems.

What is claimed is:

1. A multiple fixture lighting system for an activity area such: as an athletic field comprising:
at least one lighting fixture array disposed proximate the area to direct light onto the area;
said array comprising a plurality of fixtures containing high-intensity, electronically ballasted lamps and being mounted on a support;
said array further comprising a plurality of multi-level intensity controls for array wherein each intensity control is connected to at least one individual fixture and is capable of providing multiple operating intensity levels in relatively small intensity increments;
said array further comprising a plurality of light level sensors equal in number to the number of fixtures in the array wherein each sensor is associated with an individual fixture and capable of producing a signal related to the light intensity being produced at any given time by the lamp in said fixture;
a command center located proximate the area for selectively activating all of the fixtures in the array at selected nominal intensity levels within an available range of relatively large intensity increments; and
a logic system associated with the array and connected to receive individual fixture intensity signals from said sensors and operative to adjust individual intensity controls in relatively small intensity increments between said nominal incremental levels as necessary to achieve substantially uniform light outputs from all of the fixtures in the array.

2. A system as defined in claim 1 further including a radio link between the command center and the logic system for selecting the nominal intensity level.

3. A system as defined in claim 2 wherein said radio link is bi-directional and carries information identifying each fixture in the array.

4. A system as defined in claim 3 wherein said logic means is capable of conveying a signal to said command center identifying an individual fixture which is producing no light output.

5. A system as defined in claim 1 wherein said nominal intensity levels include a first relatively low intensity nominal level associated, with one type of activity, a second relatively higher intensity level associated with another type of activity and a third relatively higher level associated with still another type of activity.

6. A system as defined in claim 1 further including a remote command center and a radio link between said remote command center and said command center located, proximate the area.

7. A lighting system for an athletic field, comprising:
a plurality of lighting fixture clusters-arranged around the field to direct light onto the field;
each of said, clusters comprising a plurality of fixtures containing high-intensity ballasted are lamps mounted on a support, each fixture having an associated electronically variable ballast;
each of said clusters further comprising a plurality of multi-level intensity controls equal in number to the number of fixtures in the cluster wherein each intensity control is connected to an individual fixture for providing a relatively large number of closely spaced incremental lighting levels;
each of said clusters further comprising a plurality of light level sensors equal in number to the number of fixtures in the cluster wherein each sensor is associated with an individual fixture for producing a signal related to the light intensity output by the lamps in the fixture;
a local command center located proximate the athletic field for selectively activating all of the fixtures in all of the clusters at each of several available nominal intensity levels spaced from one another by multiples of said relatively small intensity increments; and
a plurality of logic systems, each of said systems being associated with an individual cluster and being responsive to inputs from said command center for selecting a nominal intensity level and further responsive to individual fixture signals from said sensors for adjusting individual fixture intensity controls by way of said electronic ballasts in said relatively small increments as necessary to achieve substantial uniformity in the light output from all of the fixtures in the clusters.

8. A system as defined in claim 7 further including a radio link between the local command center and each of said logic systems.
